(19) United States
(12) Patent Application Publication
(10) Pub. No.: US 2025/0242251 A1
(43) Pub. Date: Jul. 31, 2025

(54) HEURISTIC FOR TERMINATION OF UNIT MOVEMENT BASED ON POPULATION DENSITY

(71) Applicant: Tencent America LLC, Palo Alto, CA (US)

(72) Inventor: Ser-Geon FU, Palo Alto, CA (US)

(73) Assignee: Tencent America LLC, Palo Alto, CA (US)

(21) Appl. No.: 18/423,057

(22) Filed: Jan. 25, 2024

(51) Int. Cl. A63F 13/56

(52) U.S. Cl. CPC A63F 13/56; A63F 2300/807

(57) ABSTRACT

A method is provided for terminating movement of a first unit in a video game. The method includes obtaining a target destination on a game map for the first unit. The method includes controlling the first unit to move towards the target destination. The method includes determining a number of units in a destination area of the game map, the destination area being based on a current position of the first unit on the game map and a destination position of the target destination on the game map. The method includes determining whether to stop the movement of the first unit towards the target destination before the first unit reaches the target destination based on the destination area and the number of units in the destination area. The method includes stopping the first unit based on a determination to stop the movement of the first unit towards the target destination.

### TECHNICAL FIELD

The present disclosure relates to terminating unit movement in a video game.

### BACKGROUND

A video game includes an electronic or digital game that involves human interaction with a user interface to generate visual and/or auditory feedback on a computing device. Video games can be played on various computing devices, including consoles, personal computers, and mobile devices, such as smartphones and tablets.

Real-time strategy (RTS) is a genre of video games. In an RTS game, a player may control units by issuing commands in real-time to move to locations, gather resources, build an infrastructure, generate new units and buildings, and/or destroy units of another player. In some RTS games, a player is able to view the playing field from a bird's eye (top-down) perspective. The real-time aspect comes from the fact that players do not incrementally take turns. Instead, the players act simultaneously to maneuver units and/or position buildings under their control to win a game by destroying a core building (e.g., a command center), all buildings belonging to their opponent, or units of an opponent. For example, the first player may build ten units in a minute and the second player may build one unit in the same minute. In another example, the first player may perform ten actions before the second player is able to perform any actions.

During the game, a player directs one or more units to move to a target destination on a game map. However, a unit may not be able to reach the target destination due to a number of reasons. For example, a unit may not be able to reach the target destination when the target destination does not have enough space to accommodate the unit. When the unit is unable to reach the target destination, movement of the unit will need to be terminated before the unit reaches the target destination.

It would be beneficial to implement a heuristic that creates a more realistic stopping behavior and criteria for one or more units moving towards a target destination. It would further be beneficial if this heuristic does not involve additional complex processing or underlying data structure to support its utilization.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

The present disclosure includes a method and an apparatus of determining when to terminate movement of a unit in a video game. In an aspect, the present disclosure implements techniques to determine when an individual unit has reached its destination and when to stop the unit in a more natural manner. In an aspect, by utilizing the predictable nature of optimal circle packing in squares to terminate movement of the unit, a more realistic stopping behavior and criteria for moving one or more units to a target destination may be implemented.

An aspect of this subject matter described is implemented in a method for determining when movement of a unit to a target destination in a video game is to be terminated. The method includes obtaining the target destination on a game map for a first unit. The method also includes controlling the first unit to move towards the target destination on the game map. The method further includes determining a number of units in a destination area of the game map, the destination area being based on a current position of the first unit on the game map and a destination position of the target destination on the game map. The method further includes determining whether to stop the movement of the first unit towards the target destination before the first unit reaches the target destination based on the destination area and the number of units in the destination area. The method further includes stopping the first unit based on a determination to stop the movement of the first unit towards the target destination.

A further aspect of the subject matter described in this disclosure can be implemented in an apparatus for determining when movement of a unit to a target destination in a video game is to be terminated. The apparatus includes processing circuitry configured to obtain the target destination on a game map for a first unit. The processing circuitry is also configured to control the first unit to move towards the target destination on the game map. The processing circuitry is further configured to determine a number of units in a destination area of the game map, the destination area being based on a current position of the first unit in the game map and a destination position of the target destination in the game map. The processing circuitry is further yet configured to determine whether to stop the movement of the first unit towards the target destination before the first unit reaches the target destination based on the destination area and the number of units in the destination area. The processing circuitry is further yet configured to stop the first unit based on a determination to stop the movement of the first unit towards the target destination.

Yet another aspect of the subject matter described in this disclosure can be implemented in a non-transitory computer-readable storage medium storing computer-readable instructions thereon, which, when executed by processing circuitry, cause the processing circuitry to perform a method of determining when movement of a unit to a target destination in a video game is to be terminated. The method includes obtaining the target destination on a game map for a first unit. The method also includes controlling the first unit to move towards the target destination on the game map. The method further includes determining a number of units in a destination area of the game map, the destination area being based on a current position of the first unit in the game map and a destination position of the target destination in the game map. The method also includes determining whether to stop the movement of the first unit towards the target destination before the first unit reaches the target destination based on the destination area and the number of units in the destination area. The method further yet includes stopping the first unit based on a determination to stop the movement of the first unit towards the target destination.

To accomplish the foregoing and related ends, the one or more aspects include the features hereinafter described and particularly pointed out in the claims. The following description and the annexed drawings set forth in detail certain illustrative features of the one or more aspects. These features are indicative, however, of but a few of the various ways in which the principles of various aspects may be employed, and this description is not intended to describe all such aspects and their equivalents.

### BRIEF DESCRIPTION OF DRAWINGS

Details of one or more aspects of the subject matter described in this disclosure are set forth in the accompanying drawings and the description below. However, the accompanying drawings illustrate only some aspects of this disclosure and are therefore not to be considered limiting of its scope. Other features, aspects, and advantages will become apparent from the description, the drawings, and the claims.

FIG. 1 is a block diagram of an exemplary computing device.

FIGS. 2A-2C are schematic diagrams of virtual scenes with a group of units moving towards a shared target destination in accordance with one or more techniques of this disclosure.

FIGS. 3A and 3B are schematic diagrams of an exemplary method of performing a density check for a unit approaching a target destination in accordance with one or more techniques of this disclosure.

FIG. 4 is a flowchart of a method of terminating movement of one or more units to a target destination in a video game in accordance with one or more techniques of this disclosure.

FIG. 5 is a flowchart of a method of terminating movement of one or more units to a target destination in a video game in accordance with one or more techniques of this disclosure.

Like reference numbers and designations in the various drawings indicate like elements.

### DETAILED DESCRIPTION

The following description is directed to some exemplary aspects for the purpose of describing innovative aspects of this disclosure. However, a person having ordinary skill in the art will readily recognize that the teachings herein can be applied in a multitude of different ways.

The present disclosure includes aspects directed to determining when to terminate movement of one or more units in a video game. While the disclosure is described using one or more units in a real-time strategy (RTS) video game as an example, it is noted that the aspects of the termination of movement can be applied to one or more virtual objects in other virtual environments provided by an application run on a computing device.

A problem may arise when moving a unit or group of units to a common destination. When a group of units move together towards the target destination, the focus is often on how to move the units towards the destination in a realistic and efficient manner (e.g., pathfinding). However, an issue that may be overlooked is how to terminate the movement of the group of units in a natural manner.

This can be a difficult problem to solve because units in the group each take up a certain amount of space and may take independent paths to the target destination. In addition, another problem may be at the destination point since it may not be known ahead of time if there is enough space at the target destination to fit the group of units. This problem may be compounded when other units are already stopped at the target destination or other units are passing through the target destination.

The RTS genre includes a video game in which users, or players, construct buildings and direct units in a field of play, or game map. RTS games do not involve users taking turns such as in turn-based games like chess. Unlike chess, where each player takes turns moving pieces, in RTS games, the game rules do not limit moves by turn. Instead, RTS games proceed in real-time or continuous play where action can take place all at once. Accordingly, RTS games can be fast-paced and dynamic since users must adjust and respond in real-time. Specifically, each user can build buildings, maneuver one or more units to regions of a game map, and/or destroy buildings and/or units of an opponent.

Some RTS games provide a limited degree of control. In an example, a user specifies a strategic goal and/or issues a command to a unit or group of units. The unit or group of units performs one or more actions based on the command. For instance, a user may issue a command for a group of units to move to, or perform an attack at, a certain target location on a map. In response to the command, a game engine may determine a path to be taken by the group of units to the target location, whether to stop and attack an enemy that appears along the path to the target location, and/or how to attack enemies at the target location.

Some RTS games provide a larger degree of control such that a user specifies additional individual actions that a unit or group of units is to execute. Some RTS games provide a mix of degrees of control such that the user may choose the specificity of a command issued to a unit or group of units, and the unit or the group of units will execute the command accordingly.

An RTS game includes various game assets. For example, a unit may refer to any in-game asset that users may or may not have control over and is capable of moving around a playing field of the game, or map. Units are basic playing pieces within the RTS game. Users may build units for various purposes (e.g., such as gathering, building, attacking, defending, scouting, etc.) and command and control the units to perform specific actions in the playing field. The units may belong to different classes and each class of unit may have different strengths, weaknesses, and/or abilities. For instance, each unit may have class specific abilities and a user may control the unit to activate the ability of the respective unit by selecting the ability via a user interface. As an example, a class of units may be a tank with an ability to fire long-range missiles, while another class of units may be a worker with an ability to gather resources or build buildings.

In RTS games, the users are tasked with moving their units throughout the match. Users may control and move their units by selecting at least one unit via a user input (e.g., keys from a keyboard hotkey, using a cursor from a computer mouse, or GUI in the case of a touch screen) and then selecting a location on the game map to send one or more selected units to that location. As an example, a user may select a unit or a group of units by left clicking via a mouse and then right click on the ground of the game map to command the selected unit or group of units to move to a location of the ground of the game map. In another example, a user may use a cursor to “box select” units (e.g., left click and drag) and right click a location on the map to move the units. The user may use a hot key and/or click to command the selected units to attack or perform special abilities.

Aspects of the present disclosure can be used to address the problem of when one or more units should stop movement. For example, the aspects can allow the one or more units to stop in a more natural manner once the one or more units are determined to have reasonably reached their target destination. Aspects of the present disclosure can also improve how the units fill out available space around the target destination in a realistic and natural manner. This issue is amplified when a large number of units try to move into spaces or regions of a map with unknown surface area in an unorganized fashion. This may raise issues such as whether all the units are able to fit into a region of the map, which may cause units to continue to find different paths to the target destination, continue to move in place, and/or not properly utilize the available space.

An aspect of the present disclosure includes determining whether movement of a unit is to be terminated before it reaches a target destination. In the case of a group of units, the determination may be made for each unit in the group. For example, if a group of units have been controlled to move together to a shared target destination, only one of the units may be able to reach the exact target destination since multiple units cannot all “stop” at a single point in the map. Therefore, at best, the remaining units from the group may be positioned close to the one unit that made it to the exact target destination. This may not pose an issue when commanding a single unit to a target destination that is empty. However, this may be an issue when a single unit is commanded to a target destination that was initially empty (e.g., empty when the user commanded the single unit to move to the target location) but has other units around the target destination once the single unit approaches the target destination. In addition, another issue to consider is when a group of units are commanded to move to a shared target destination and the shared target destination does not have enough space to fit the group of units.

A unit may be determined to have reasonably reached a target destination based on a distance threshold. For example, movement of a unit is terminated when a distance between the unit and the target destination is less than the distance threshold. However, this may appear mechanical and does not allow units to naturally fill in available space around the target destination.

A unit may be determined to have reasonably reached a target destination based on a collision. For example, movement of the unit is terminated based on the collision with another unit or obstacle on the map when approaching the target destination. However, this may lead to premature stopping along a path to the target destination before the unit is close to the target destination and create roadblocks. In some cases, the unit may try to reach the target destination when another unit is blocking their path, resulting in the unit walking in place for a period of time (e.g., five seconds) and then stopping, or continuously moving and attempting different paths to the target destination. However, this may look unrealistic and mechanical and may cause units to appear to be stuck in a loop.

A target destination of one or more units may be unreachable or blocked. When the target destination is unreachable or blocked by other units, crowd movement issues may be dealt with in different ways. For example, units may be directed to “walk through” each other by temporarily disabling unit collision for these units. Allowing units in the group the ability to walk through each other for a short period of time can help resolve movement deadlock that occurs when units compete with each other to reach a target destination. In an example, the units may appear to look like they are not moving while a simulation in the background continues to try and make the units move toward the destination. In an example, the units may “give up” and stop if the units are not able to make any more progress towards the destination after a given amount of time.

Another approach to addressing movement termination and/or pathfinding issues is to group units to move in specific formations. For example, a group of 100 units may be grouped together and move in a specific formation of a 10 by 10 square formation. Since the group of units is moving in a fixed 10×10 square formation, calculating whether there is enough space to fit the 10×10 square formation around the target destination can be simplified by treating the group of 100 units as a 10×10 square formation. Accordingly, once a single unit from the 10×10 square formation reaches a location associated with the target destination, the entire group of units may be considered to have reached the target destination and every unit may stop. If units are already at the target destination, the group of units may stop once a single unit from the 10×10 square formation collides with a unit at the location. However, this approach may appear mechanical and specific formations may not optimally “fill in” the spaces at target destinations.

As another method, groups of units may move in implicit formations. Unlike specific formations, the formation used by units in an implicit formation is defined by the units' relative position to each other when they are initially selected. However, the problem is that as the units move according to the path, individual units may jostle each other such that the units eventually lose their initial formation as they approach a target destination.

In the above solutions, movement of the units can often look stiff and mechanical and may not allow the group of units to “fill in” available spaces at target destinations. In addition, the formation-based movement may cause a “traffic jam” type blockage at a target destination.

Aspects of the present disclosure include a method of determining when a unit should stop when the unit is close to a target destination in a video game. For example, the stopping heuristic described in the present disclosure creates a relatively realistic stopping behavior and defines stopping criteria for an individual unit or groups of individual units moving in tandem towards the target destination. By implementing the stopping heuristic, movement of the individual units may be terminated when an area around the destination has become overcrowded. That is, the individual units may preemptively give up trying to reach the destination as soon as the respective unit is determined to be close enough to the target destination. In addition, aspects of the present disclosure can help ensure that units properly stop around a region of the target destination which can also allow the units to fill out available space as much as possible around the target destination.

Aspects of the present disclosure may be applied to any video game in which movement of one or more units to a target destination is affected by available space at the target destination. For example, the affected movement may be for a single unit that moves to a target destination that is occupied by one or more other units. In another example, the affected movement may be for a group of units that move as a group to the target destination. It is noted that the units may be computer-controlled and need not be controlled by a user. For example, aspects of the present disclosure may be applied to video games with large moving crowds, video games where units must move through large, crowded areas, and/or areas with a large number of individual units and limited space or paths on a playing field.

Aspects of the present disclosure can improve when groups of units stop when approaching user designated locations. In addition, as compared to related movement methods, aspects of the present disclosure can eliminate, or reduce, visual anomalies of units walking in place or continually trying to reach locations that are unreachable due to any number of reasons (e.g., target destination is on an impassable region of the map, target destination is off the map, units are blocking the target destination, etc.). In addition, realistic human crowd behavior can be emulated due to the units making reasonable efforts to reach the target destination before stopping, and not just giving up prematurely. As an example, aspects of the present disclosure allow a group of units moving towards the same target destination to stop in a realistic and natural manner once each unit is determined to have reasonably reached the destination and fill in available space around the target destination. Furthermore, aspects of the disclosure do not involve additional complex processing or an extra underlying data structure to support its utilization.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different system configurations, networks, interactive methods, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatuses and methods. These apparatuses and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing circuitry). One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some aspects, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media, such as at least one non-transitory computer-readable storage medium. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

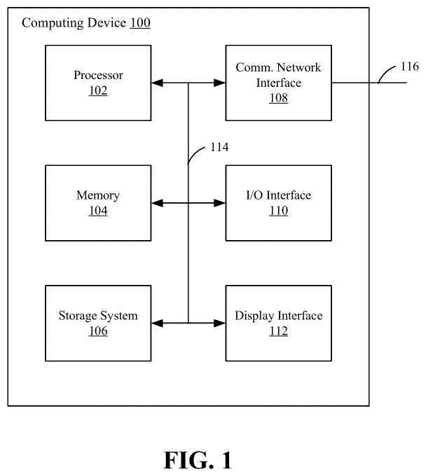

FIG. 1 is a block diagram of an exemplary computing device 100. A computing device 100 includes at least a processor 102, a memory system 104, a storage system 106, a communication network interface 108, an input/output (I/O) interface 110, and a display interface 112 communicatively coupled to a bus 114. The processor 102 is configured to execute executable instructions (e.g., programs). In some aspects, the processor 102 includes circuitry or any processor capable of processing the executable instructions.

As described herein, a device, such as the computing device 100, may refer to any user device, apparatus, or system configured to perform one or more techniques described herein. For example, a user device may be a client device, a computer (e.g., a personal computer (PC)), a desktop computer, a laptop computer, a tablet computer, a computer workstation, or a mainframe computer, a phone, a smart phone, a video game platform or console, a handheld device (e.g., a portable video game device or a personal digital assistant (PDA)), a wearable computing device (e.g., a smart watch), an augmented reality device, a virtual reality device, a display or display device, a television, a television set-top box, a network device, a digital media player, a video streaming device, a content streaming device, an in-car computer, or any other device configured to perform one or more techniques described herein. Processes herein may be described as performed by a particular component (e.g., a CPU), but, in further aspects, can be performed using other processing components configured to perform the described processes.

The computing device 100 may be any user device with a processor and memory. While many user devices on which to play video games are different, the user devices may share some common characteristics. For instance, the user devices may have some method of capturing user input such as a computer mouse, keyboard, remote control, touchscreen, game controller, or the like. In addition, the different user devices may also have some method of displaying a two-dimensional image using a display such as a TV screen or computer monitor (e.g., LED, LCD, or OLED) or touchscreen. In some devices, the user devices may have some method of displaying a three-dimensional image using a display such as a head-set display or augmented reality device. The user devices may have some form of processing CPU, although the capability often widely varies in terms of capability and performance. Further, in some aspects, the user devices may have a connection to the internet, such as an Ethernet connection, WiFi connection, or mobile phone cell data connection.

In various aspects, one or more users may utilize their respective computing device to play one or more video games, including a computer game, mobile game, cloud game, or console game. The computing device 100 may display a virtual scene of a virtual environment, such as the playing field, with units, virtual buildings, one or more user interfaces (UIs), and/or visual displays associated with the game. The user interfaces may be configured to receive user selections (e.g., user input) for displaying visual menus, selecting units for use in the game, or controlling virtual objects within an RTS game, for example. There may be any number of menus that provide opportunity for user selection via buttons, radio buttons, check boxes, sliders, text fields, selectable objects, moveable objects, and/or the like.

A virtual scene in a video game may refer to a specific section, area, or instance of the game world, such as the playing field. It is a representation of the game world, focusing on a particular portion of the playing field for example. In an example, the virtual scene corresponds to the virtual environment at a portion of the playing field that is displayed to a user. The virtual scene may be from the perspective of a virtual camera, for example.

The virtual environment in a video game may refer to the entire game world or the playing field where the gameplay takes place. In an example, the virtual environment corresponds to the entire playing field. The virtual environment may include interconnected digital spaces that encompass multiple virtual scenes, levels, or areas. For example, in a virtual environment, the focus is not only on the visual aspects but also on interactivity, usability, and/or the integration of various game mechanics, such as physics, artificial intelligence, and user input. The virtual environment can serve as the backdrop for gameplay and user interactions, to provide a cohesive and immersive experience.

The memory system 104 is any memory configured to store data. Some examples of the memory system 104 are storage devices, such as random-access memory (RAM) or read-only memory (ROM). The memory system 104 can include a RAM cache. In various aspects, data is stored within the memory system 104. The data within the memory system 104 may be cleared or ultimately transferred to the storage system 106.

The storage system 106 is any storage configured to retrieve and store data. Some examples of the storage system 106 are flash drives, hard drives, optical drives, and/or magnetic tape. In some aspects, the computing device 100 includes a memory system 104 in the form of RAM and a storage system 106 in the form of flash data. Both the memory system 104 and the storage system 106 include computer readable media which may store instructions or programs that are executable by a computer processor including the processor 102.

The communication network interface 108 can be coupled to a network (e.g., communication network) via a link 116. The communication network interface 108 may support communication over an Ethernet connection, a serial connection, a parallel connection, or an ATA connection, for example. The communication network interface 108 may also support wireless communication (e.g., 802.11 a/b/g/n, WiMax). It will be apparent to those skilled in the art that the communication network interface 108 can support any number of wired and wireless standards.

The I/O interface 110 is any device that receives input from the user and outputs data. The display interface 112 is any device that is configured to output graphics and data to a display. In one example, the display interface 112 is a graphics adapter.

It will be appreciated by those skilled in the art that the hardware elements of the computing device 100 are not limited to those depicted in FIG. 1. The computing device 100 may include more or less hardware elements than those depicted. Further, hardware elements may share functionality and still be within various aspects described herein.

From both a visual standpoint and a functional standpoint, strategy games have to reconcile when a unit or a large group of units that moves to a target destination should stop through some form of formation or stopping criteria. As described above, using discrete formations when moving a group of units can be a straightforward way to solve issues involved with when, where, and how individual units in a group should stop when the units are close to a target destination. When each individual unit has a distinct separate destination they are trying to reach in a target region (e.g., due to the need to maintain a formation), there is a lower likelihood of deadlock situations where units may obstruct each other in their attempt to reach and stop at a target destination. A simple check against the formation may be used to determine if space around the target destination is limited and the formation may be adjusted or transformed (e.g., rotated or shifted) to accommodate the limited size. However, a downside to a formation-based approach is that the number of units that may be part of a group may be limited to avoid the formation from becoming too unwieldy and difficult to manage. In addition, the formation-based approach does not take into account what happens when other units move into the target region at a later point in time (e.g., after the initial command to move units is set). For games that have units moving in formation, the number of units that may be assigned to a formation (e.g., or group) is relatively low. For games that allow formations of a large number of units, the map is usually very wide open with little to no obstructions that may hinder formation movement or the units in formation may be treated as one unit as a whole.

In addition, temporarily disabling collisions between units when approaching a target destination may not be desirable. As described above, collisions may be temporarily disabled between units that have already reached the destination and units that are still in the process of reaching the destination. This allows units that are attempting to reach the destination to “pass through” other units that are idle due to the idle units having already been determined to “reach” the destination. This approach may be acceptable when units are spaced further apart and there are sizable margins between the units. However, this approach may not be visually desirable when units are tightly packed with little marginal spacing between the units and/or in complex maps. For example, having units “passing through” each other is visually unappealing.

Aspects of the present disclosure can support larger group sizes of units (e.g., within the range of hundreds of units). Aspects of the present disclosure can also support unit stopping criteria in more complex maps, such as maps with obstructions designed to create movement bottlenecks, in which a formation-based approach would be cumbersome.

Furthermore, aspects of the present disclosure include a stopping heuristic that allows one or more units, including a group of units, to move and stop at their target destination in a more freeform and organic manner such that the game feels more fluid and looks more realistic.

When implementing a stopping heuristic, various factors may need to be considered. One factor is whether the stopping heuristic causes one or more units to move in an efficient and/or realistic manner. Another factor may be a number of units to be moved. For example, in some aspects, it would be beneficial to use the stopping heuristic to move a large number of units to spaces or regions of a map with unknown surface area in an unorganized fashion.

By implementing aspects described in the present disclosure, a determination can be made as to when the area around the destination has become overcrowded and an individual unit can stop attempting to reach the destination. That is, a determination can be made that the individual unit is close enough or has reasonably reached the destination based on the determination of crowdedness in the area. Accordingly, aspects of the present disclosure can help ensure that an individual unit stops at an appropriate location at or around a target destination region in a realistic manner and/or also fills out the available space around the destination region.

Exemplary scenarios that arise when one or more units determine how, when, or where to stop when approaching a target destination are described below. In an example, a determination of when individual units that are moving towards the same destination in a group with other units have reasonably reached a destination target or stop trying to continue to get closer to the destination target.

As an initial matter, a unit should stop attempting to reach a target destination if the target destination is unreachable. The target destination may be unreachable if the target destination is outside a valid region of the map, off the playing field, or in an impassable region on the map. In some aspects, the target destination may be modified to a valid target destination that is reachable by the unit, such as a valid destination on the map. In an example, the target destination is updated to a closest valid location on the map. The target destination may also be unreachable if it is surrounded and/or blocked off by one or more other units, which would physically block off access to that area. A separate system that identifies these disjointed regions and adjusts the target destination accordingly may be utilized in these cases.

In some cases, another unit may already be located at a target destination. A unit moving to the target destination may simply stop when it collides with the other unit and is determined to have reached the target destination.

A target destination and a region associated with the target destination may be too crowded with other units. Having a unit attempt to push its way into a crowd of other units may lead to deadlocks. These deadlocks may occur if two units attempting to move in opposite directions collide head on. Deadlocks may also occur when an active, or engaged, unit pushes against an idle unit, while the idle unit is in a position where it is not possible for the idle unit to move or be pushed aside.

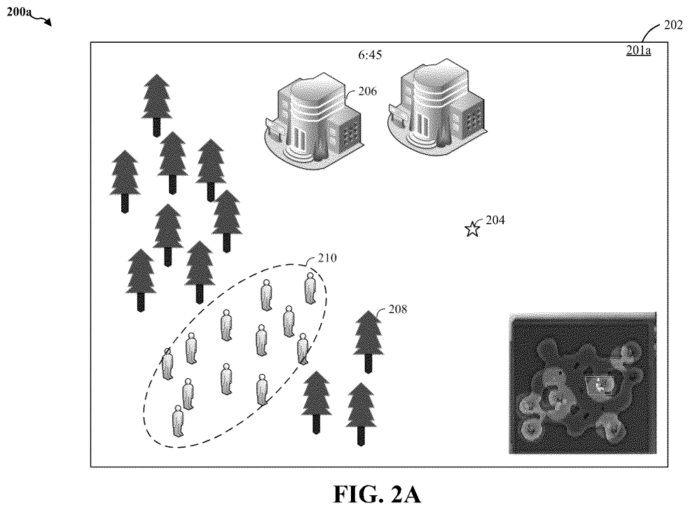

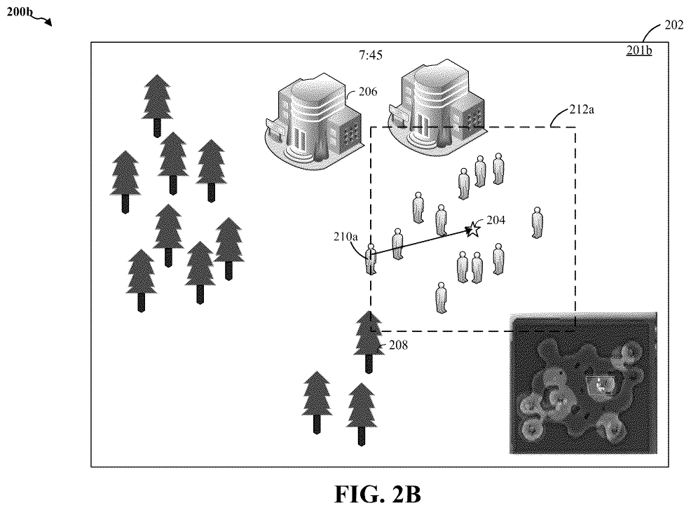

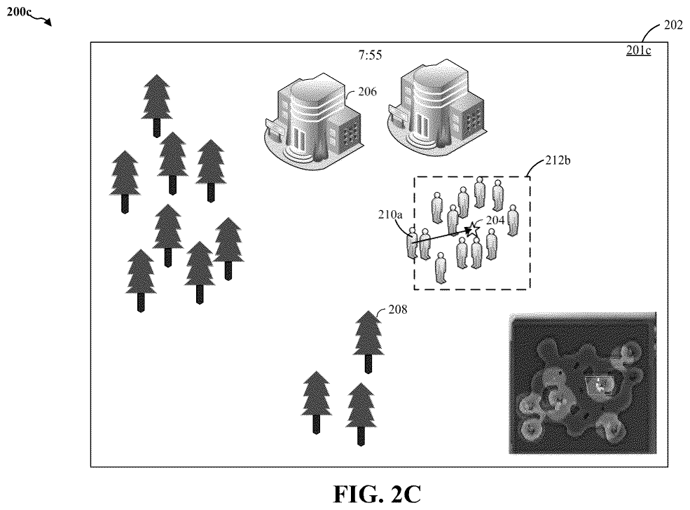

FIGS. 2A-2C are schematic diagrams of virtual scenes with a group of units moving in tandem towards a target destination according to aspects of the present disclosure. While pertinent features are shown, those of ordinary skill in the art will appreciate from the present disclosure that various other features have not been illustrated for the sake of brevity and so as not to obscure more pertinent aspects of the exemplary implementations disclosed herein.

The virtual scenes in examples 200a-200c may be generated by a computing device 202 that is configured to execute the video game. The virtual scenes may be generated by a server or cloud server, and streamed to the computing device 202 in other examples.

The virtual scenes 201a-201c of a game map may include at least a group of units 210. The virtual scenes 201a-201c may include other game elements such as at least one virtual building 206 and at least one obstacle 208. In some aspects, the game map refers to a current playing field for the video game and may include the totality of the area in which units may move around in.

A virtual building 206 may refer to any in-game asset that is stationary. Obstacles may refer to non-passable areas on the game map that units are required to go around. Obstacles may include, but are not limited to holes (e.g., lakes, water hazards), cutouts, or vertical protrusions (e.g., trees, mountain terrain, cliffs, etc.) on the game map. As shown in FIG. 2A, the obstacles 208 may include trees which the units cannot move through.

A group of units may comprise of one or more units. An individual unit may on its own be considered a group of one unit. Each unit is an in-game asset that a user may or may not have control over. In some aspects, the unit is capable of moving around the game map. In some aspects, each unit may be in an idle state, an engaged state, or an anchored state. An idle state can refer to units that are currently not engaged in performing any active commands and are usually not moving when in the idle state. Units that are in an idle state may be pushed out of the way by other units. Units in an engaged state may refer to units that have an assigned attack or defend target and are in the process of moving to attack or defend the target. Engaged units may push idle units in the direction that the engaged units are attempting to move towards. Units in an anchored state may refer to units that are either actively attacking a target or in a special state where the anchored units cannot move or be moved.

As shown in example 200a of FIG. 2A, the group of units 210 are commanded to move towards a target destination 204 and none of the units have reached the target destination 204 yet. In some aspects, a group refers to a group of one or more units where each unit within the group is within a certain distance (e.g., 0.25 m) of at least one other unit in the group. In some aspects, the group of units may be in any formation (specific or implicit) that may change as the units move along a path and as the units reach their target destination. In some aspects, the group of units may have no formation at all.

In some aspects, the groups are further subdivided based on the states of the units. As an example, anchored units may only be in a same group as other anchored units. As another example, idle units must be in a group with other idle units. In yet another example, units that are moving may only be in the same group as other units moving towards a same destination.

A target destination 204 may refer to a pin-point target location or any other region that one or more units is controlled to move to. In some aspects, a unit is considered to have reached its target destination when a distance between its center of mass and the destination is less than a defined size of the unit, which is generally the radius of a bounding sphere, or other shape, that encapsulates the unit.

A reasonable solution may be to have a unit stop attempting to reach its target destination once the unit detects that the region around the target destination is too crowded. A crowdedness measure that can used in some aspects, utilizes the idea of optimal packing of circles inside a square to determine a quantitative measure. However, the packing in aspects of the disclosure is not limited to circles and/or squares. In addition, in correlating details related to the size of a square needed to optimally pack a certain number of circles a secondary consideration was recognized. The density measure of an amount of area taken up by the circles compared to the squares that most tightly wraps around them has a fairly consistent upper bound-especially, as the number of circles increase.

FIG. 2B shows an example of how a determination is made that an individual unit 210a among the group of units 210 has reached the target destination 204 by performing a density check around the region of the target destination 204.

As shown in example 200b of FIG. 2B, after a period of time, the majority of the group of units 210 have reached the target destination 204. However, at least the unit 210a from the group of units 210 has not reached the target destination. Accordingly, the unit 210a performs a density check in a region associated with the target destination 204 by generating a square 212a. The square 212a may be generated based on a location of the unit 210a relative to the target destination 204. In an example, the square 212a is centered on the target destination 204 and a current position of the unit 210a on the border. The density check can be performed in relation to the target destination 204 and units, virtual buildings, and/or any obstacles around the target destination may affect whether the region associated with the target destination 204 is too crowded for the unit 210 to continue to move towards. As shown in example 200b, since the square 212a around the target destination region does not appear crowded yet, the unit 210a may continue to move towards the target destination 204 and, as the unit 210a moves closer towards the target destination 204, the density check may create smaller squares.

It should be noted that the density check may be performed using various shapes in other aspects. However, use of the square or a rectangular shape may allow the computations required for the density check to be reduced or simplified.

As shown in example 200c of FIG. 2C, after another period of time, the unit 210a moves closer towards the target destination 204 and performs another density check by generating a square 212b around the target destination that is smaller than the square 212a shown in example 200b of FIG. 2B. Accordingly, the square 212b has become more crowded than the previous square 212a shown in FIG. 2B. In some aspects, when an area occupied by the group of the units 210 and/or a ratio between that area taken up by the group of the units 210 and the area of the square 212b reaches one or more thresholds, the movement of the unit 210a may stop. The movement of the unit 210a may be stopped because the density check indicates that the unit 210 may be considered to have reasonably reached the target destination 204. In other words, a target destination region has become too crowded and the unit 210a can no longer move closer to the target destination 204.

Although FIGS. 2A-2C only shows a single unit from a group of the units approaching the target destination and performing a density check along the path to the target destination to determine whether to stop, it should be noted that each unit, or each of a subset of units, that approaches the target destination may perform a respective density check. Density checks may be performed for subgroups of units in some aspects. Accordingly, the square used for the density check may be distinct for each unit that approaches the target destination 204.

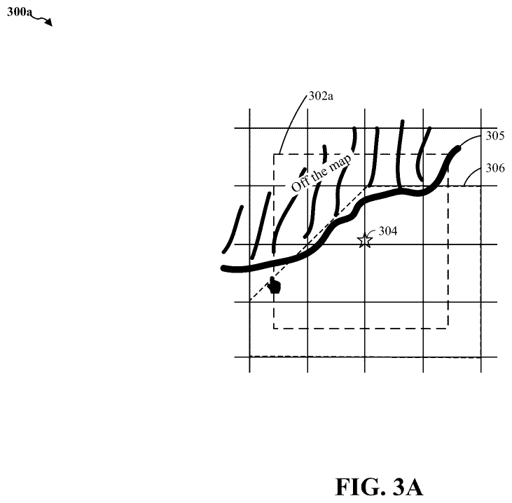

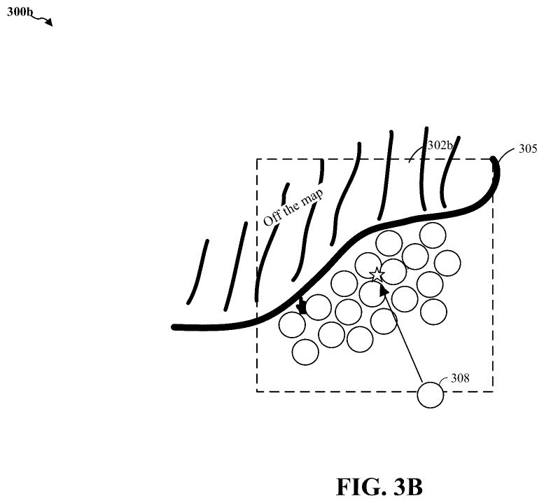

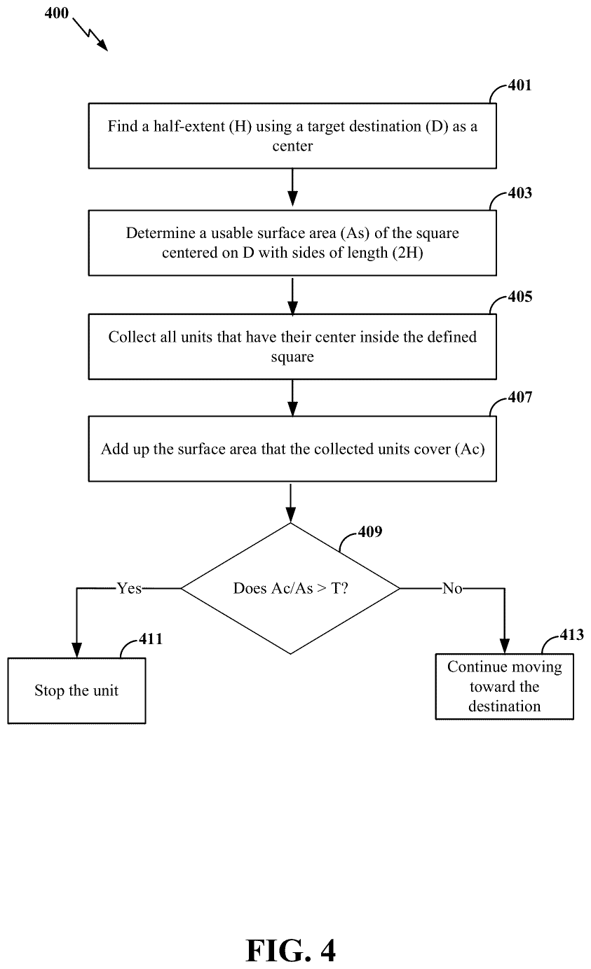

In some aspects, the density check may be performed when one or more conditions are met. The density check may not need to be performed for every single game frame. Instead, the density check may be triggered by certain conditions such as when a unit collides into another unit or when the unit is within a distance threshold of a target destination. The density check will be described below in more detail with reference to FIGS. 3A-3B and FIG. 4.

In an example, the density check using the square is not performed until the unit collides with another game element because the collision may indicate that the unit may be in a crowded area close to the target destination 204. In an example, the density check performed in response to a collision may be performed for one or more certain types of collisions. For example, the density check may be performed when the unit collides with another unit. The other unit may or may not be included in the same group. In an example, the density check may be performed when the unit collides with another unit in the same group. The density check may further depend on a state of the other unit, for example whether the unit is stationary. In addition, it should be noted that even though a square was used as an example to check for density, any appropriate shape may be used.

FIGS. 3A and 3B are schematic diagrams of a density check for a unit that moves to a target destination according to aspects of the present disclosure. While pertinent features are shown, those of ordinary skill in the art will appreciate from the present disclosure that various other features have not been illustrated for the sake of brevity and so as not to obscure more pertinent aspects of the example implementations disclosed herein.

In some aspects, a square created as part of the density check may be an axis aligned bounding box. As an example, the square may align itself to the X and Y axis of a game map. In some aspects, the square may not be aligned to the X and Y axis of the game map.

As shown in example 300a of FIG. 3A, a shape, such as a square 302a, may be created as part of a density check performed by one or more units approaching a target destination 304. However, part of the square 302a is over an impassable region of the map (e.g., marked as off the map) and passable regions 306 of the map as demarcated by a game map border 305. In some aspects, the game map border 305 may depict a cliff, fence, or a river.

As shown in example 300b of FIG. 3B, a density check is performed for a unit 308 by generating a square 302b around the target destination 304 to determine whether the region around, or associated with, the target destination 304 is crowded. In some aspects, the unit 308 is part of a group of units. In some aspects, the unit 308 does not have to be part of a group of units to perform the density check since other units, virtual buildings, or impassable objects may be next to the target destination 304.

FIG. 4 is a flowchart of a method of implementing a heuristic to determine when one or more units of a group of units moving to a target destination in a video game should stop in accordance with one or more techniques of this disclosure. While pertinent features are shown, those of ordinary skill in the art will appreciate from the present disclosure that various other features have not been illustrated for the sake of brevity and so as not to obscure more pertinent aspects of the example implementations disclosed herein.

In FIG. 4, the method 400 may be performed by an apparatus, such as a computing device (e.g., the computing device 100 shown in FIG. 1), as described above. In some implementations, the method 400 is performed by processing logic (e.g., processing circuitry), including hardware, firmware, software, or a combination thereof. In some implementations, the method 400 is performed by a processor executing code stored in a non-transitory computer-readable storage medium (e.g., a memory). The method 400 includes implementing a stopping heuristic that is applied to a unit moving toward a target destination (e.g., stopping criteria).

At step 401, the method 400 may include finding a half-extent (H) by using a target destination (D) as a center point. The half-extent may be used to define a minimum square size that includes a current position (P) of the unit on a border of the square. As an example, referring back to FIG. 2B, for the unit 210a that moves towards a target destination 204, the density check can be implemented by finding a half-extent to define a square 212a that uses the target destination 204 as a center point. As another example, referring to FIG. 3B, for the unit 308 that moves towards a target destination 304, the density check can be used to determine whether the region around the target destination is crowded.

Given the minimum square that has the destination position as its center and includes the current position of the unit, it is then necessary to find the “usable” area of the square. At step 403, the method 400 may include determining a usable surface area (As) of the square centered on D with length 2H. This may be the same as an area of the square. However, due to the underlying map potentially containing obstructions that would reduce the “usable” area that units may effectively occupy, that area may be less. Accordingly, in some aspects, there is a need to estimate the approximate usable size. In some cases, if the game map is on a fixed square grid, then the underlying grid may be utilized to estimate an amount of usable space within the square.

As an example, referring back to FIG. 3A, the square 302a corresponds to the area with which the usable area is to be estimated. The solid black grid lines mark out the underlying grid for the game map, while the passable regions 306 mark out an area that may be used to estimate the usable area due to the game map border 305. As shown in example 300a, the passable regions 306 appear to be a bit of an overestimation of the actual usable area. However, in some aspects, this may not be an issue due to a few factors. First, it is more computationally efficient to simply check whether the square overlaps with a map grid square than try to compute an amount of overlap. This efficiency is a reason why circle parking in a circle was not used because checking whether a map grid square overlaps with a circle is even more computationally expensive. Second, as will be described below in step 405, all units with their centers in the square may be included in the density calculation, which means that there may be a slight over estimation of the amount of space taken up by the units as the units do not need to be fully inside the square. For example, given that the map grid squares may be a fixed size (e.g., 0.0625 m²), it is easy to estimate the usable area by counting the full and half grid squares in the square that has overlaps.

Given the usable area of the square around the target destination, at step 405, the method 400 includes collecting all units that have their center inside the defined square. While it is more computationally expedient to check if a point is inside a square as opposed to being inside a circle, a circle may be used in other aspects, for example to increase accuracy of the density check. When the squares in FIG. 3A are also axis aligned, it may take no more than four floating point comparisons to ascertain whether a point is inside a square. By contrast, to check if a point is inside a circle, there is a need to find a distance between the center and the point, which at least involves two squaring of floating point values, and, potentially, a square root operation.

As an example, referring back to FIGS. 2B and 2C, twelve units are determined to be inside the defined squares 212a, 212b. As another example, referring back to FIG. 3B, twenty units are determined to be inside the defined square 302b.

At step 407, the method 400 includes adding up the surface area that the units cover (A_{c}). This step assumes that each unit occupies the space of a circle given their center and a radius to define their size. When all the units within range are collected, calculating the corresponding surface area that the units take up is straightforward since all units are considered to have a circular footprint. To simply the operation, the total surface area taken up by the units is the sum of the squares of their radii multiplied by π.

Σ₁ⁿrᵢ²π=πΣ₁ⁿrᵢ²

In some aspects, predetermined occupancy areas may be assigned to different types of units such that calculation of the surface area taken up by an individual unit may be simply obtained instead of calculated.

With the usable area of the square and the area taken up by units “within” the square, an estimate of the density around the destination may be calculated. For example, based on optimal circle packing in squares, the maximum density may be around 0.785. To account for the overestimating that has occurred in method 400 and the fact that the circles being packed are usually heterogenous (e.g., of differing radii), the density threshold may be loosened. In some aspects, based on the maximum density being around 0.785, the density threshold may be reduced to 0.65.

At step 409, the method 400 includes determining whether A_{c}/Aₛ>T, where T is the density threshold. If it is determined that A_{c}/Aₛ>T, then, at step 411, the method 400 may determine that the area is too crowded and the unit may stop. If it is determined that A_{c}/Aₛ≤T, then, at step 413, the method 400 may determine that the unit is not too crowded and the unit may continue moving towards the destination.

As noted above, the method 400 may not need to be executed at every frame for each unit that is moving toward a target destination. Instead, the unit may perform the method 400 under specific conditions as an optimization. For example, conditions that may trigger the method 400 may include a first unit (e.g., Unit A) colliding with a second unit (e.g., Unit B) while the unit is moving toward a target destination and either (1) the second unit is part of a group of units that overlaps the target destination position or (2) the second unit (e.g., Unit B) is part of the same group as the first unit, is closest to the target destination, and/or has already reached the target destination. The definition of a group overlapping a target destination position is, for example, when the axis-aligned bounding box (AABB), which his formed by the units in the group, contains the target destination.

The present disclosure presents a method 400 of converting a qualitative measure of crowdedness and converting it into a tangible quantitative measurement. The measure may further be performed while minimizing processing overhead. The method 400 can be applied whether there is a group of units moving into an unoccupied space or a single unit moving into an area that is occupied by at least one other unit.

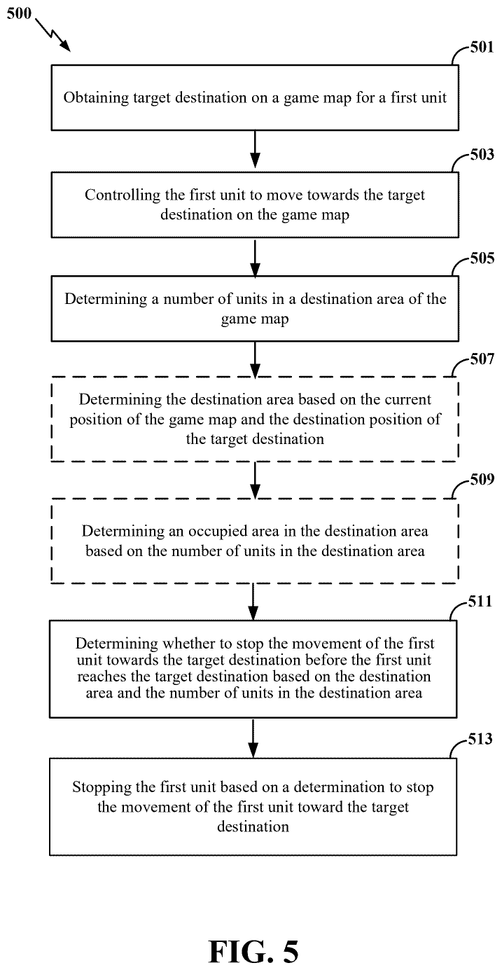

FIG. 5 is a flowchart of a method of determining when a unit moving to a target destination in a video game should stop in accordance with one or more techniques of this disclosure. While pertinent features are shown, those of ordinary skill in the art will appreciate from the present disclosure that various other features have not been illustrated for the sake of brevity and so as not to obscure more pertinent aspects of the example implementations disclosed herein.

In FIG. 5, the method 500 may be performed by an apparatus, such as a computing device (e.g., the computing device 100 shown in FIG. 1), as described above. In some implementations, the method 500 is performed by processing logic (e.g., processing circuitry), including hardware, firmware, software, or a combination thereof. In some implementations, the method 500 is performed by a processor executing code stored in a non-transitory computer-readable storage medium (e.g., a memory). The method 500 includes improving when units in a group that are moving to a target destination in a video game should stop.

At block 501, the method 500 may include obtaining the target destination on a game map for a first unit. In some aspects, the target destination may be automatically obtained by a computer. In some aspects, a user may use a cursor to select a target destination directly on a game map. As an example, referring back to FIG. 2A, a user controls a group of units 210 to move towards a target destination 204.

In some aspects, the obtaining the target destination on the game map may include obtaining the target destination of the game map for a group of units such that the group of units are controlled to move together toward the target destination on the game map. The first unit may be part of the group of units.

In some aspects, obtaining the target destination may include, based on a determination that the target destination is unreachable, setting the target destination to a different location, such as a closest reachable location, on the game map. As an example, referring back to FIG. 3A, if a user selects a target destination that is off the map, then the target destination may be adjusted to a new target destination 304 that is located at the closest reachable location on the game map. Accordingly, users may be notified if units are able to reach a target destination at the time they issue their command rather than have the units aimlessly wandering around or exploring different paths to reach the target destination.

At block 503, the method 500 may include controlling the first unit to move towards the target destination on the game map. As an example, referring back to FIG. 2A, a first unit of the group of units is moving towards the target destination 204 on the game map 201a. As another example, referring back to FIG. 3B, a unit if moving toward the target destination 304.

At block 505, the method 500 may include determining a number of units in a destination area of the game map. The destination area may be based on a current position of the first unit in the game map and a destination position of the target destination in the game map.

In some aspects, determining the number of units may include determining the number of units in the destination area of the game map in response to the first unit colliding with a second unit while moving towards the target destination.

In some aspects, in response to the first unit colliding with the second unit while moving towards the target destination, controlling the first unit to pause for a time period before determining whether to stop the movement of the first unit towards the target destination. In some aspects, the first unit may be part of a group of units that is controlled to move towards the target destination and the second unit may be included in the group of units. In some aspects, the second unit may not be grouped with the first unit to move towards the target destination.

Optionally, at block 507, the method 500 may include determining the destination area based on the current position of the game map and the destination position of the target destination.

Optionally, at block 509, the method 500 may include determining an occupied area in the destination area based on the number of units in the destination area. In some aspects, the determining whether to stop the movement of the first unit towards the target destination may include determining whether to stop the movement of the first unit based on the destination area, the occupied area, and a threshold. In some aspects, the threshold may be a density threshold. In some aspects, determining whether the first unit reaches the target destination may include determining whether to stop the movement of the first unit towards the target destination based on the density threshold and a ratio of the destination area and the occupied area.

As an example, referring back to FIG. 2C, as unit 210a collides with a second unit while moving toward the target destination 204, the number of units in the destination area of the map based on the current position of the unit 210a and the destination position of the target destination 204 is determined and a determination of whether the unit 210a has reached the target destination is based on the square 212b and the number of units in the destination area (e.g., density).

At block 511, the method 500 may include determining whether to stop the movement of the first unit towards the target destination before the first unit reaches the target destination based on the destination area and the number of units in the destination area. As an example, this is described in detail in method 400 of FIG. 4. In some aspects, the determining whether to stop the movement of the first unit towards the target destination includes determining whether to stop the movement of the first unit based on the destination area, the occupied area, and a threshold.

At block 513, the method 500 may include stopping the first unit based on a determination to stop the movement of the first unit towards the target destination. In some aspects, stopping the first unit may include setting the first unit in an idle mode. The first unit may not be currently engaged in performing active commands in the idle mode.

In some aspects, the video game may be a real-time strategy (RTS) game.

Although the present disclosure is explained in the context of an RTS game in a video game, the subject matter described herein may be implemented in any video games that utilize large numbers of moving entities that move in tandem in a group towards a shared target destination. In addition, there is no condition that the moving entities are controlled by a user. Instead, the moving entities need to simultaneously move towards a shared target destination as a group in an unorganized and ad-hoc fashion. The present disclosure makes sure that the moving entities stop properly around a target destination region while also filling out as much available space as possible.

The present disclosure also presents other improvements in a qualitative sense on how a unit or units in a group move around can naturally stop when approaching user designated locations. Other improvements include eliminating the visual anomalies of units walking in place or trying to reach locations that are clearly unreachable due to any one of the reasons presented in the previous sections. At the same time, the units visually appear to make an effort in reaching the target destination before giving up and not just giving up prematurely.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing unit may be implemented in hardware (e.g., by processing circuitry), software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware.

What is claimed is:

1. A method of terminating movement of a first unit, the method comprising:
obtaining a target destination on a game map for the first unit;
controlling the first unit to move towards the target destination on the game map;
determining a number of units in a destination area of the game map, the destination area being based on a current position of the first unit on the game map and a destination position of the target destination on the game map;
determining whether to stop the movement of the first unit towards the target destination before the first unit reaches the target destination based on the destination area and the number of units in the destination area; and
stopping the first unit based on a determination to stop the movement of the first unit towards the target destination.

2. The method of claim 1, wherein the obtaining the target destination comprises:
obtaining the target destination on the game map for a group of units such that the group of units are controlled to move together towards the target destination on the game map, wherein the first unit is part of the group.

3. The method of claim 1, wherein the determining the number of units comprises:
determining the number of units in the destination area of the game map in response to the first unit colliding with a second unit while moving towards the target destination.

4. The method of claim 3, further comprising:
in response to the first unit colliding with the second unit while moving towards the target destination, controlling the first unit to pause for a time period before the determining whether to stop the movement of the first unit towards the target destination.

5. The method of claim 3, wherein
the first unit is part of a group of units that is controlled to move towards the target destination, and
the second unit is included in the group of units.

6. The method of claim 4, wherein the second unit is not grouped with the first unit to move towards the target destination.

7. The method of claim 1, further comprising:
determining the destination area based on the current position of the game map and the destination position of the target destination;
determining an occupied area in the destination area based on the number of units in the destination area, and
the determining whether to stop the movement of the first unit towards the target destination includes determining whether to stop the movement of the first unit based on the destination area, the occupied area, and a threshold.

8. The method of claim 7, wherein
the threshold is a density threshold, and
the determining whether to stop the movement of the first unit towards the target destination includes determining whether to stop the movement of the first unit based on the density threshold and a ratio of the destination area and the occupied area.

9. The method of claim 1, wherein the stopping the first unit comprises:
setting the first unit in an idle mode, wherein the first unit is not currently engaged in performing active commands in the idle mode.

10. The method of claim 1, wherein the obtaining the target destination further comprises:
based on a determination that the target destination is an unreachable location on the game map, setting the target destination to a different location on the game map.

11. The method of claim 1, wherein the game map is for a real-time strategy (RTS) game.

12. An apparatus, comprising:
processing circuitry configured to:
obtain a target destination on a game map for a first unit;
control the unit to move towards the target destination on the game map;
determine a number of units in a destination area of the game map, the destination area being based on a current position of the first unit on the game map and a destination position of the target destination on the game map;
determine whether to stop movement of the first unit towards the target destination before the first unit reaches the target destination based on the destination area and the number of units in the destination area; and
stop the first unit based on a determination to stop the movement of the first unit towards the target destination.

13. The apparatus of claim 12, wherein the processing circuitry is further configured to:
obtain the target destination on the game map for a group of units such that the group of units are controlled to move together towards the target destination on the game map, wherein the first unit is part of the group.

14. The apparatus of claim 12, wherein the processing circuitry is further configured to:
determine the number of units in the destination area of the game map in response to the first unit colliding with a second unit while moving towards the target destination.

15. The apparatus of claim 14, wherein the processing circuitry is further configured to:
in response to the first unit colliding with the second unit while moving towards the target destination, control the first unit to pause for a time period before the determining whether to stop the movement of the first unit towards the target destination.

16. The apparatus of claim 14, wherein
the first unit is part of a group of units that is controlled to move towards the target destination, and
the second unit is included in the group of units.

17. The apparatus of claim 15, wherein the second unit is not grouped with the first unit to move towards the target destination.

18. The apparatus of claim 12, wherein the processing circuitry is further configured to:
determine the destination area based on the current position of the game map and the destination position of the target destination;
determine an occupied area in the destination area based on the number of units in the destination area, and
determine whether to stop the movement of the first unit based on the destination area, the occupied area, and a threshold.

19. The apparatus of claim 18, wherein
the threshold is a density threshold, and
the processing circuitry is configured to determine whether to stop the movement of the first unit based on the density threshold and a ratio of the destination area and the occupied area.

20. A non-transitory computer-readable storage medium storing computer-readable instructions thereon, which, when executed by processing circuitry, cause the processing circuitry to perform a method of terminating movement of a first unit, the method comprising:
obtaining a target destination on a game map for the first unit;
controlling the first unit to move towards the target destination on the game map;
determining a number of units in a destination area of the game map, the destination area being based on a current position of the first unit on the game map and a destination position of the target destination on the game map;
determining whether to stop the movement of the first unit towards the target destination before the first unit reaches the target destination based on the destination area and the number of units in the destination area; and
stopping the first unit based on a determination to stop the movement of the first unit towards the target destination.
